(19) United States
(12) Patent Application Publication
(10) Pub. No.: US 2011/0268195 A1
(43) Pub. Date: Nov. 3, 2011

(54) DEVICE AND METHOD FOR MULTIVIEW VIDEO DECODING

(75) Inventor: Yuya SHIGENOBU, Nara (JP)

(73) Assignee: PANASONIC CORPORATION, Osaka (JP)

(21) Appl. No.: 13/181,130

(22) Filed: Jul. 12, 2011

Related U.S. Application Data
(63) Continuation of application No. PCT/JP2010/000205, filed on Jan. 15, 2010.

(30) Foreign Application Priority Data
Jul. 29, 2009 (JP) 2009-176192

(51) Int. Cl. H04N 7/26

(52) U.S. Cl. 375/240.25; 375/E07.027

(57) ABSTRACT

In a multiview video decoding device conforming to H.264/AVC, the amount of calculation in a reordering process on a reference picture list is reduced. This is achieved as follows. A view index selector extracts only an entry or entries whose view IDs correspond to an inter-view reference flag which is 1 from a view ID list which defines an association between view indices and view IDs, stores the view indices of the extracted entry or entries as search targets into a view index storing section, and searches for and selects a view index which is equal to a given variable picViewIdxLX (X is 0 or 1). A view ID selector stores the view IDs of the extracted entry or entries as a reference picture list, and selects a view ID based on an address of an entry hit in the view index storing section.

### CROSS-REFERENCE TO RELATED APPLICATIONS

This is a continuation of PCT International Application PCT/JP2010/000205 filed on Jan. 15, 2010, which claims priority to Japanese Patent Application No. 2009-176192 filed on Jul. 29, 2009. The disclosures of these applications including the specifications, the drawings, and the claims are hereby incorporated by reference in their entirety.

### BACKGROUND

The present disclosure relates to devices and methods for multiview video decoding.

Multiview video coding (MVC) is a technique of compressing multiview video at a high compression ratio by utilizing inter-view redundancy as well as temporal redundancy. The technique includes both temporal prediction and inter-view prediction (see International Publication WO2007/081926).

FIG. 1 is a timing diagram for describing picture referencing in a conventional multiview video decoding device. Arrows in FIG. 1 indicate the order in which pictures are decoded. Pictures belonging to the same view are identified by picture numbers (picNum), and views are identified by view IDs (view_id). Each of pictures of views other than a base view which references no other views can reference pictures of the same view and pictures of different views at the same time.

In decoding devices conforming to H.264/AVC, a decoded picture buffer (DPB) is used to manage reference pictures in a unified manner. A reference picture list (RPL) is used in which reference pictures stored in the DPB are associated with reference indices (refIdx) which specify the entries of the reference pictures. By assigning smaller reference indices (refIdx) to pictures which are more frequently referenced, the compression ratio can be improved. Therefore, encoding devices are adapted to modify the reference picture list.

FIG. 2 is a conceptual diagram showing a conventional procedure of reordering the reference picture list in MVC. In FIG. 2, a reference character 100 indicates an initial reference picture list, a reference character 100a indicates an updated reference picture list, a reference character 110 indicates a view ID list which defines an association between 4-bit view indices (view_index) and 10-bit view IDs (view_id). Note that a variable (j) called an inter-view reference index in the standard is herein shortened to “view index” (view_index) for the sake of convenience.

The initial reference picture list is defined in the standard and may be directly used without modification. The reference picture list may be modified as follows when necessary. Pictures to be associated are specified in ascending order of reference index (refIdx). In this case, picture numbers (picNum) are specified for pictures of the same view. View IDs (view_id) are specified for pictures of different views via view indices (view_index), but not directly.

FIG. 3 is a flowchart showing a conventional procedure of handling the reference picture list, and FIG. 4 is a diagram showing details of a search procedure and a merge procedure in the reordering process of FIG. 3 (see Gary J. Sullivan et al., “Editors' draft revision to ITU-T Rec. H.264 |ISO/IEC 14496-10 Advanced Video Coding—in preparation for ITU-T SG 16 AAP Consent (in integrated fowl),” Feb. 2009, retrieved from the Internet: <URL: http://wftp3.itu.int/av-arch/jvt-site/2009_{—}01_Geneva/JVT-AD007.zip>).

In FIG. 3, step S1 is to generate an initial reference picture list Initial RefPicListX (X is 0 or 1), step S2 is to decode the variable modification_of_pic_nums_idc, step S3 is to determine whether or not the variable modification_of_pic_nums_idc is 3 (when modification_of_pic_nums_idc=3, the reordering process is ended), and step S4 is to determine whether or not the variable modification_of_pic_nums_idc is 0, 1, or 2 (when modification_{—of}_pic_nums_idc=0, 1, or 2, control proceeds to step S5 which is a reordering process before MVC). When the variable modification_of_pic_nums_idc is 4 or 5, control proceeds from step S4 to step S6. Step S6 is to decode the variable abs_diff_view_idx_minus1, step S7 is to derive the variable picViewIdxLX (X is 0 or 1), step S8 is to derive a target view ID, and step S9 is a reordering process in MVC.

In FIG. 4, a reference character C1 indicates details of the search procedure in the reordering process and a reference character C2 indicates the merge procedure in the reordering process, and both the procedures are written in the C language.

FIG. 5 is a block diagram showing a configuration for carrying out the search procedure C1 in the reordering process on the reference picture list in a conventional multiview video decoding device. In FIG. 5, a reference character 11 indicates a Golomb decoder, a reference character 12 indicates a picViewIdxLX deriving section, a reference character 20 indicates a target view ID deriving section, a reference character 21 indicates a view index putting section, a reference character 22 indicates a (non_)anchor_ref_IX storing section, a reference character 23 indicates a (non_)anchor_ref_1X referencing section, a reference character 30 indicates a view ID selector, a reference character 31 indicates a reference index putting section, a reference character 32 indicates an Initial RefPicListX storing section, a reference character 33 indicates a view ID comparator, and a reference character 34 indicates an Initial RefPicListX search section.

The Golomb decoder 11 decodes an input stream to obtain the variable modification_of_pic_nums_idc and the variable abs_diff_view_idx_minus1. The picViewIdxLX deriving section 12 derives the 4-bit variable picViewIdxLX (X is 0 or 1).

In the target view ID deriving section 20, the (non_)anchor_ref_1X storing section 22 references the array anchor_ref_1X[i][j] or non_anchor_ref_1X[i][j] (X is 0 or 1), and stores the view ID list 110 which defines an association between 4-bit view indices (view_index) and 10-bit view IDs (view_id) as described above in FIG. 2. The view index putting section 21 puts a 4-bit view index (view_index) corresponding to a given variable picViewIdxLX (X is 0 or 1) into the (non_)anchor_ref_1X storing section 22 under the control of the (non_)anchor_ref_1X referencing section 23. A 10-bit view ID (view_id) read from the (non_)anchor_ref_1X storing section 22 is supplied as a target View ID to the view ID comparator 33.

In the view ID selector 30, the Initial RefPicListX storing section 32 stores the initial reference picture list 100 described in FIG. 2 (X is 0 or 1). The reference index putting section 31 successively updates and puts the reference indices (refIdx) into the Initial RefPicListX storing section 32 under the control of the Initial RefPicListX search section 34. A 10-bit view ID (view_id) read from the Initial RefPicListX storing section 32 is supplied to the view ID comparator 33. The view ID comparator 33 compares the target View ID supplied from the target view ID deriving section 20 with a view ID (view_id) read from the Initial RefPicListX storing section 32 over 10 bits. The entry position of a view ID (view_id) matching the target View ID is moved up in the reference picture list.

As described above, conventionally, there is a problem that, in the reordering process on the reference picture list in MVC, the view ID comparator 33 performs the 10-bit comparison calculation, resulting in a large amount of calculation.

### SUMMARY

The present disclosure describes implementations of a technique of reducing the amount of calculation in the reordering process on the reference picture list.

An example multiview video decoding device according to the present disclosure excludes comparison calculation of view IDs having a long bit length in at least one of the search procedure and the merge procedure.

According to the present disclosure, the amount of calculation in the reordering process on the reference picture list can be reduced.

### BRIEF DESCRIPTION OF THE DRAWINGS

FIG. 1 is a timing diagram for describing picture referencing in a conventional multiview video decoding device.

FIG. 2 is a conceptual diagram showing a conventional reordering procedure on the reference picture list.

FIG. 3 is a flowchart showing a conventional procedure of handling the reference picture list.

FIG. 4 is a diagram for describing details of a search procedure and a merge procedure of the reordering process of FIG. 3.

FIG. 5 is a block diagram showing a configuration for carrying out a search procedure of a reordering process on the reference picture list in a conventional multiview video decoding device.

FIG. 6 is a block diagram showing a configuration for carrying out a search procedure of a reordering process on the reference picture list in a multiview video decoding device according to a first embodiment of the present disclosure.

FIG. 7 is a conceptual diagram for describing operation of the configuration of FIG. 6.

FIG. 8 is a block diagram showing a configuration for carrying out a search procedure of a reordering process on the reference picture list in a multiview video decoding device according to a second embodiment of the present disclosure.

FIG. 9 is a conceptual diagram for describing operation of the configuration of FIG. 8.

FIG. 10 is a block diagram showing a configuration for carrying out a search procedure of a reordering process on the reference picture list in a multiview video decoding device according to a third embodiment of the present disclosure.

FIG. 11 is a conceptual diagram showing a search procedure and a merge procedure of a reordering process on the reference picture list in a multiview video decoding device according to a fourth embodiment of the present disclosure.

FIG. 12 is a conceptual diagram showing the initial reference picture list before reshaping which is to be subjected to the search procedure in the multiview video decoding device of the present disclosure.

FIG. 13 is a conceptual diagram showing a reordering process which starts to be performed after reshaping of the initial reference picture list of FIG. 12.

FIG. 14 is a conceptual diagram showing a reordering process which starts to be performed from the initial reference picture list of FIG. 12 which is adapted to include all entries.

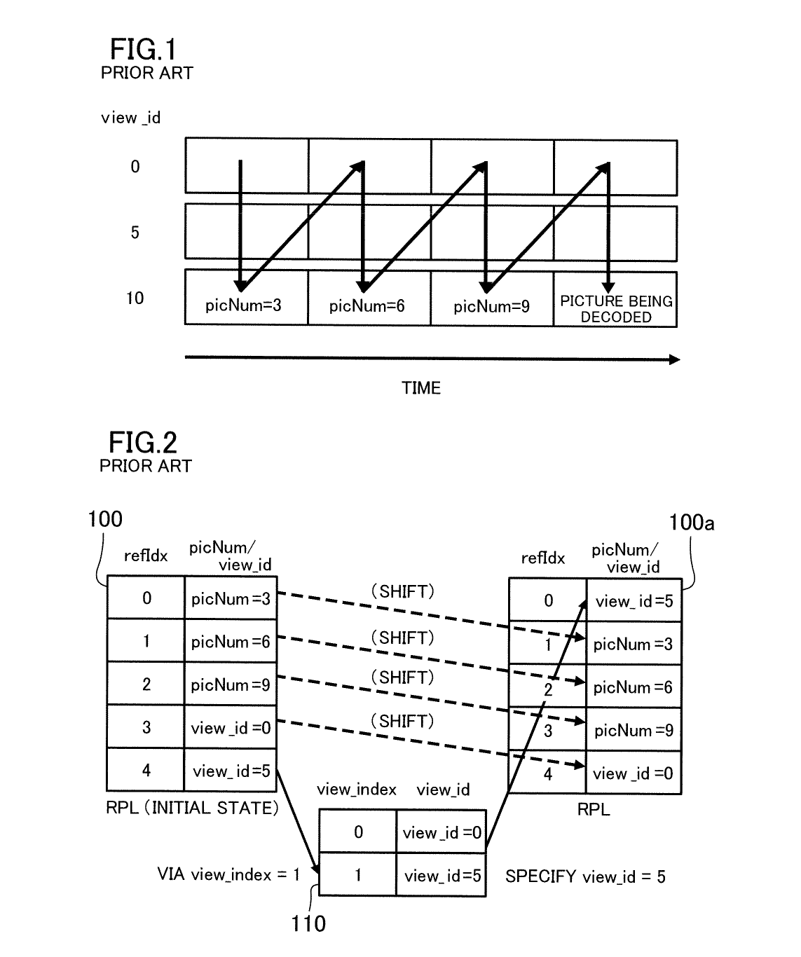

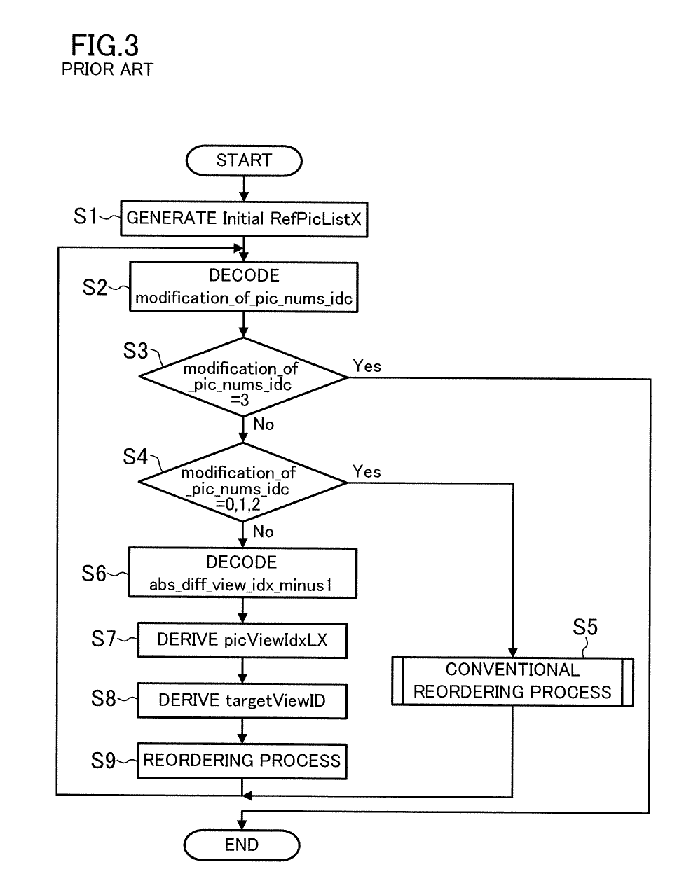

### DETAILED DESCRIPTION

Embodiments of the present disclosure will be described in detail hereinafter with reference to the accompanying drawings.

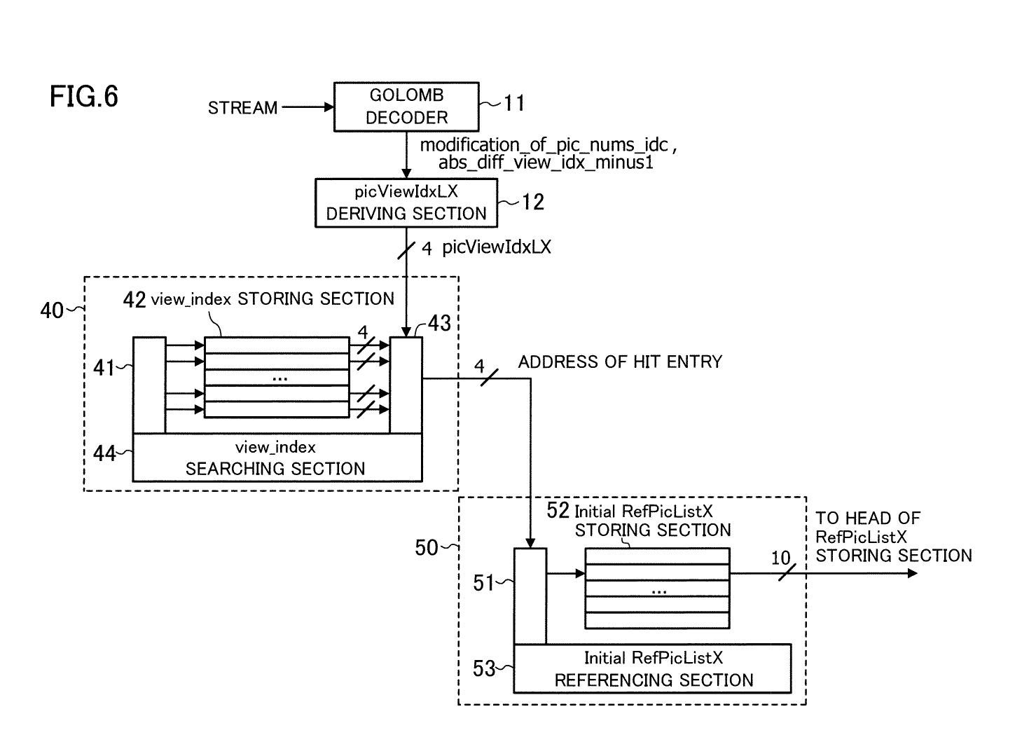

FIG. 6 is a block diagram showing a configuration for carrying out a search procedure C1 of a reordering process on the reference picture list in a multiview video decoding device according to a first embodiment of the present disclosure. In FIG. 6, a reference character 11 indicates a Golomb decoder, a reference character 12 indicates a picViewIdxLX deriving section, a reference character 40 indicates a view index selector, a reference character 41 indicates a reference index putting section, a reference character 42 indicates a view_index storing section, a reference character 43 indicates a view index comparator, a reference character 44 indicates a view_index searching section, a reference character 50 indicates a view ID selector, a reference character 51 indicates a reference index putting section, a reference character 52 indicates an Initial RefPicListX storing section, and a reference character 53 indicates an Initial RefPicListX referencing section.

The multiview video decoding device of FIG. 6 conforms to H.264/AVC. In the multiview video decoding device, the array anchor_ref_1X[i][j] or non_anchor_ref 1X[i][j] (X is 0 or 1) is referenced to extract only an entry or entries whose inter-view reference flag (inter_view_flag) corresponds to a view ID (view_id) which is 1. The extracted entry or entries are stored as search targets together with a view index (j). In the reordering process on the reference picture list RefPicListX, when the variable modification_of_pic_nums_idc is 4 or 5, the process of determining an inter-view prediction reference picture which is to be inserted into RefPicListX[refIdxLX] (X is 0 or 1) is performed by searching for the view index (j) which is equal to the variable picViewIdxLX (X is 0 or 1).

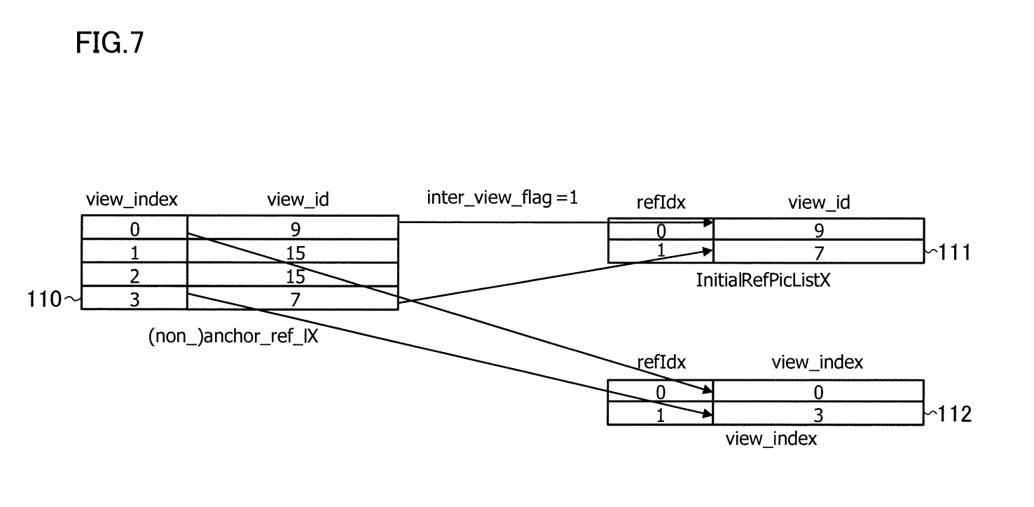

FIG. 7 is a conceptual diagram for describing operation of the configuration of FIG. 6. In FIG. 7, only a view ID or IDs (view_id) whose inter-view reference flags (inter_view_flag) are 1 are selected from the view ID list 110 containing anchor_{—ref}_1X or non_anchor_{—ref}_{—1X to create a first list 111. A view index or indices (view}_index) whose inter-view reference flags (inter_view_flag) are 1, of the view ID list 110 containing anchor_ref_1X or non_anchor_ref_IX, are newly stored as a second list 112.

As described in FIG. 2, the view ID list 110 is an array which defines an association between 4-bit view indies (view_index) and 10-bit view IDs (view_id). The first list 111 indicates an association between reference indices (refIdx) and view IDs (view_id). The second list 112 indicates an association between reference indices (refIdx) and view indices (view_index).

The view_index storing section 42 of FIG. 6 stores the second list 112, and the Initial RefPicListX storing section 52 stores the first list 111. Therefore, the conventional 10-bit comparison calculation is replaced with 4-bit comparison calculation which is performed by the view index comparator 43, resulting in a reduction in the amount of calculation.

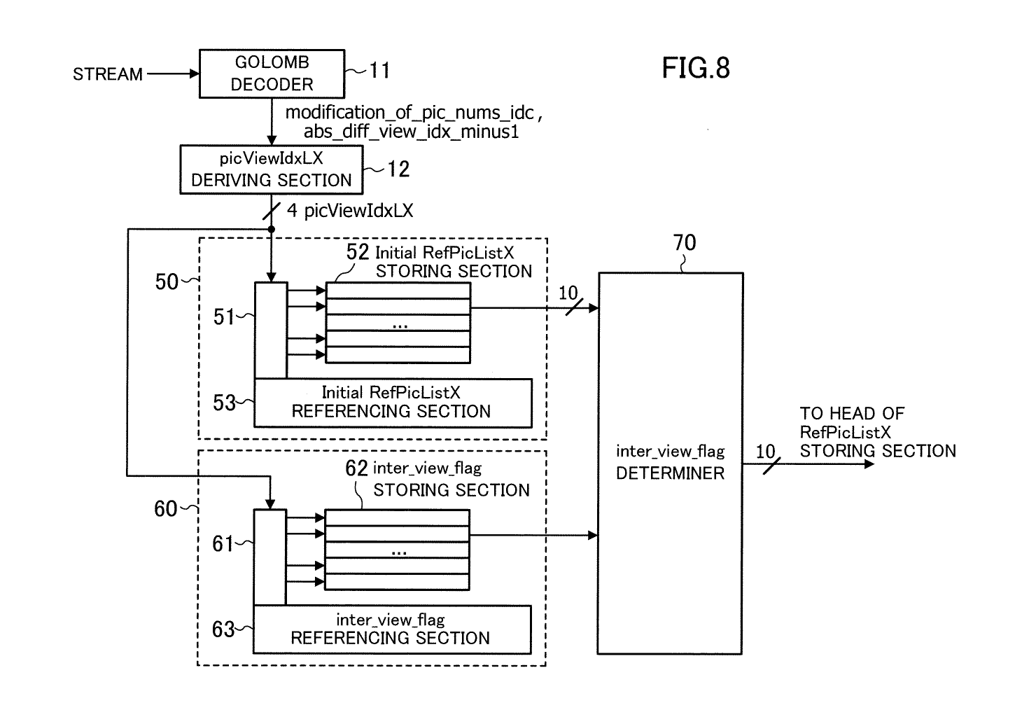

FIG. 8 is a block diagram showing a configuration for carrying out a search procedure C1 of a reordering process on the reference picture list in a multiview video decoding device according to a second embodiment of the present disclosure. In FIG. 8, a reference character 11 indicates a Golomb decoder, a reference character 12 indicates a picViewIdxLX deriving section, a reference character 50 indicates a view ID selector, a reference character 51 indicates a reference index putting section, a reference character 52 indicates an Initial RefPicListX storing section, a reference character 53 indicates an Initial RefPicListX referencing section, a reference character 60 indicates an inter-view reference flag selector, a reference character 61 indicates a reference index putting section, a reference character 62 indicates an inter_view_flag storing section, a reference character 63 indicates an inter_view_flag referencing section, and a reference character 70 indicates an inter_view_flag determiner

The multiview video decoding device of FIG. 8 conforms to H.264/AVC. In the reordering process on the reference picture list RefPicListX, when the variable modification_of_pic_nums_idc is 4 or 5, the process of determining an inter-view prediction reference picture to be inserted into RefPicListX[refIdxLX] (X is 0 or 1) is performed by referencing the array anchor_ref_1X[i][j] or non_anchor_ref 1X[i][j] (X is 0 or 1) using the variable picViewIclxLX (X is 0 or 1) as an index, and is validated only when an inter-view reference flag (inter_view_flag) corresponding to the referenced view ID (view_id) is 1.

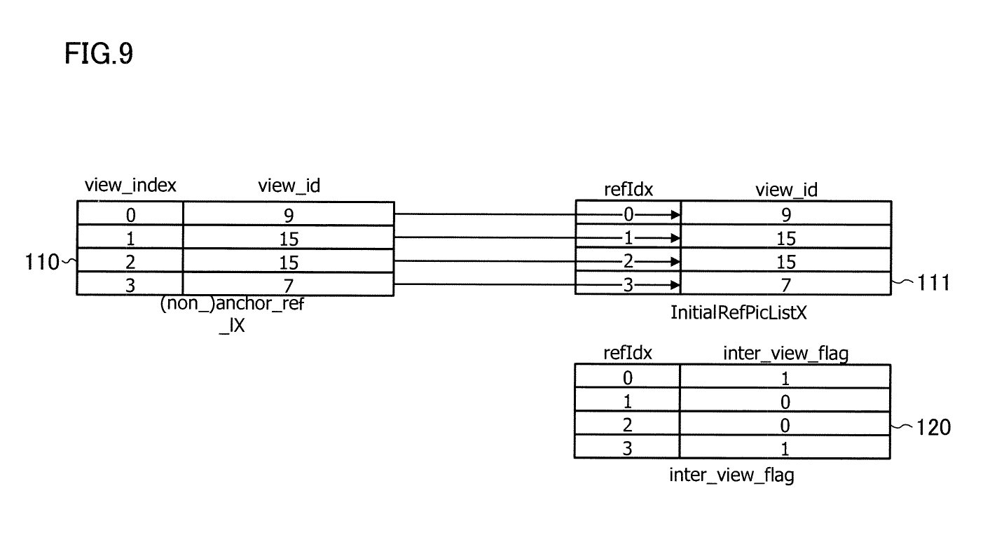

FIG. 9 is a conceptual diagram for describing operation of the configuration of FIG. 8. According to FIG. 9, the view IDs (view_id) of the view ID list 110 containing anchor_ref_1X or non_anchor_ref_1X are directly selected as a first list 111 irrespective of the inter-view reference flag (inter_view_flag), and the inter-view reference flags (inter_view_flag) corresponding the view IDs (view_id) are newly stored as a second list 120.

As described in FIG. 2, the view ID list 110 is an array which defines an association between 4-bit view indies (view_index) and 10-bit view IDs (view_id). The first list 111 indicates an association between reference indices (refIdx) and view IDs (view_id). The second list 120 indicates an association between reference indices (refIdx) and inter-view reference flags (inter_view_flag).

The Initial RefPicListX storing section 52 of FIG. 8 stores the first list 111, and the inter_view_flag storing section 62 stores the second list 120. Therefore, no comparison calculation is required, so that the amount of calculation is smaller than that of the first embodiment.

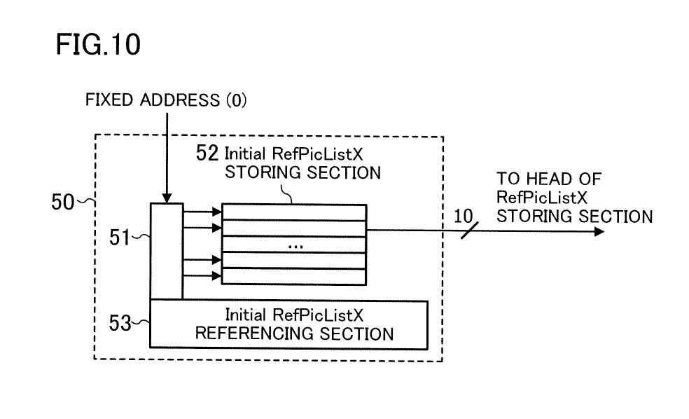

FIG. 10 is a block diagram showing a configuration for carrying out a search procedure C1 of a reordering process on the reference picture list in a multiview video decoding device according to a third embodiment of the present disclosure. In FIG. 10, a reference character 50 indicates a view ID selector, a reference character 51 indicates a reference index putting section, a reference character 52 indicates an Initial RefPicListX storing section, and a reference character 53 indicates an Initial RefPicListX referencing section. The aforementioned picViewIdxLX deriving section 12 is not provided.

The multiview video decoding device of FIG. 10 conforms to H.264/AVC. In the reordering process on the reference picture list RefPicListX, when the variable modification_of_pic_nums_idc is 4 or 5, the process of determining an inter-view prediction reference picture to be inserted into RefPicListX[refIdxLX] (X is 0 or 1) is performed by referencing the array anchor_ref_1X[i][j] or non_anchor_ref_1X[i][j] (X is 0 or 1) using a fixed value (e.g., 0) as an index without deriving the variable picViewIdxLX (X is 0 or 1), and is validated only when an reference inter-view reference flag (inter_view_flag) corresponding to the referenced view ID (view_id) is 1.

For example, if a three-dimensional image is decoded, the number of views is two, and one of the two views is a base view which does not reference the other. Therefore, refIdx which is used to determine an inter-view prediction reference picture may be a fixed value. Although the third embodiment is applicable only to three-dimensional images, the third embodiment advantageously has a lower amount of calculation than that of the second embodiment.

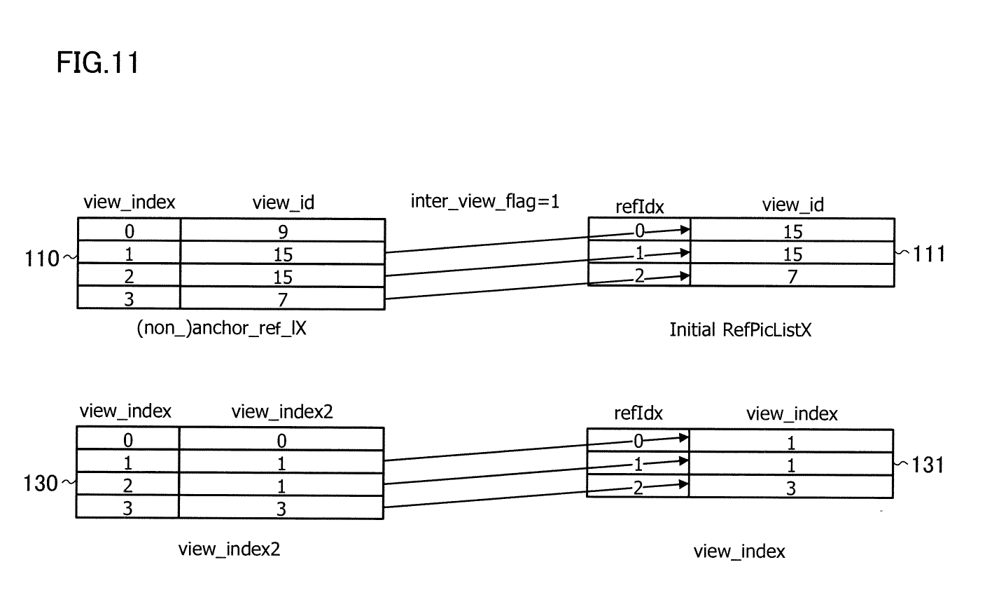

FIG. 11 is a conceptual diagram showing a search procedure C1 and a merge procedure C2 of a reordering process on the reference picture list in a multiview video decoding device according to a fourth embodiment of the present disclosure. Here, assuming that the search procedure C1 is carried out by the configuration of FIG. 6 of the first embodiment, an improvement in the merge procedure C2 will be described.

The multiview video decoding device of the fourth embodiment conforms to H.264/AVC. The array anchor_ref_1X[i][j] or non_anchor_ref_1X[i][j] (X is 0 or 1) is referenced to extract only an entry or entries whose view IDs (view_id) correspond to an inter-view reference flag (inter_view_flag) which is 1. A plurality of view indices (j) corresponding to entries holding the same view ID (view_id) are converted into any one of the view indices (j). The extracted entry or entries are stored as search targets together with the converted view index (j). Thereafter, in the reordering process on the reference picture list RefPicListX, when the variable modification_of_pic_nums_idc is 4 or 5, the variable picViewIdxLX (X is 0 or 1) is converted as with the view index (j), the process of determining an inter-view prediction reference picture to be inserted into RefPicListX[refIdxLX] (X is 0 or 1) is performed by searching for the converted view index (j) which is equal to the converted variable picViewIdxLX (X is 0 or 1), and the process of determining an inter-view prediction reference picture which is to be inserted after RefPicListX[refIdxLX] (X is 0 or 1) is performed by searching entries located after RefPicListX[refIdxLX] (X is 0 or 1) for the converted view index (j) which is not equal to the converted variable picViewIdxLX (X is 0 or 1).

According to FIG. 11, for the entries which hold the same view ID (view_id), any of the view indices (view_index) is selected as a representative and is stored as a new view index (view_index2), and the new view index is used to perform a process similar to that of the first embodiment.

More specifically, according to FIG. 11, only a view ID or IDs (view_id) whose inter-view reference flags (inter_view_flag) are 1 are selected from the view ID list 110 containing anchor_ref_1X or non_anchor_ref_1X to create a first list 111. As described in FIG. 2, the view ID list 110 is an array which defines an association between 4-bit view indices (view_index) and 10-bit view IDs (view_id). The first list 111 indicates an association between reference indices (refIdx) and view IDs (view_id).

On the other hand, a previously prepared second list 130 indicates an association between view indices (view_index) and new view indices (view_index2). Here, in the view ID list 110, an entry whose view index (view_index) is 1 and an entry whose view index (view_index) is 2 have the same view ID (view_id) that is 15. Therefore, for these entries, the second list 130 stores 1 which is a representative view index (view_index) as a new view index (view_index2). Thereafter, only a new view index or indices (view_index2) whose inter-view reference flags (inter_view_flag) are 1 are selected from the second list 130 to create a third list 131. The third list 131 thus created indicates an association between reference indices (refIdx) and view indices (view_index) which are allowed to be redundant. As a result, even when there are entries having the same view ID (view_id) in the view ID list 110, the merge procedure can be correctly performed.

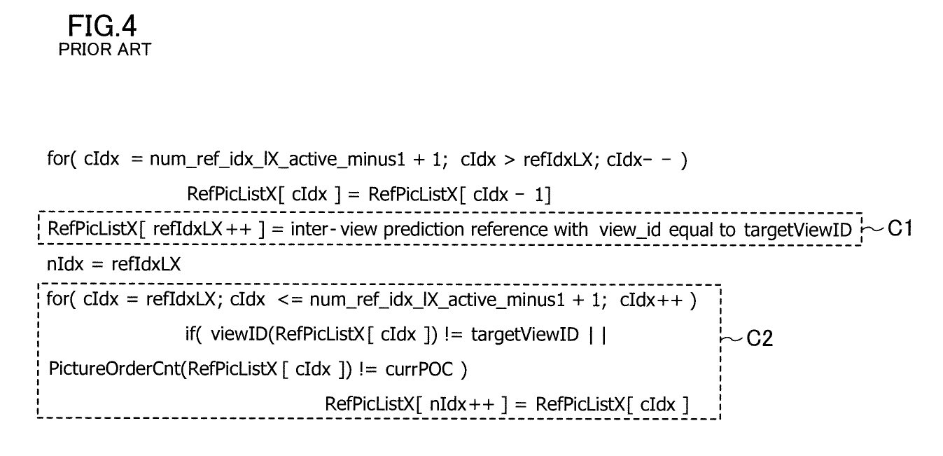

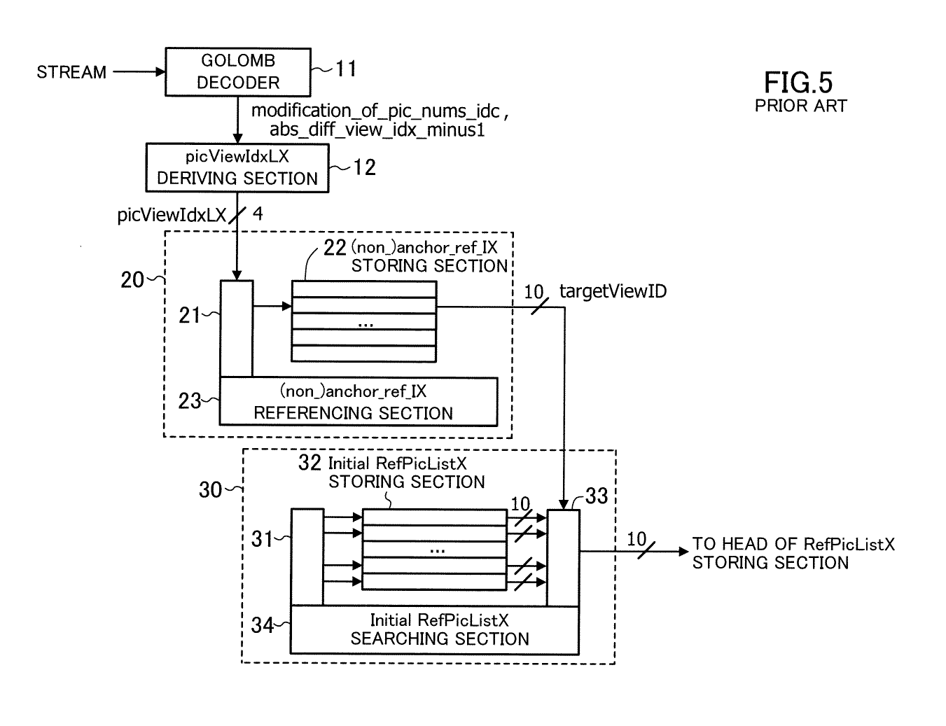

In this embodiment, “view ID (RefPicListX[cldx])!=target View ID” in the merge procedure C2 of FIG. 4 is replaced with comparison of view indices (view_index) in the third list 131, i.e., the 10-bit comparison calculation is replaced with the 4-bit comparison calculation, resulting in a reduction in the amount of calculation.

Although it has been assumed above that the search procedure C1 of FIG. 4 is applied to the initial reference picture list (Initial RPL), this is, strictly speaking, slightly different from the standard. Although only entries for inter-view prediction are shown in FIGS. 7, 9, and 11, the present disclosure is also applicable to a case where the MVC process and the non-MVC process coexist.

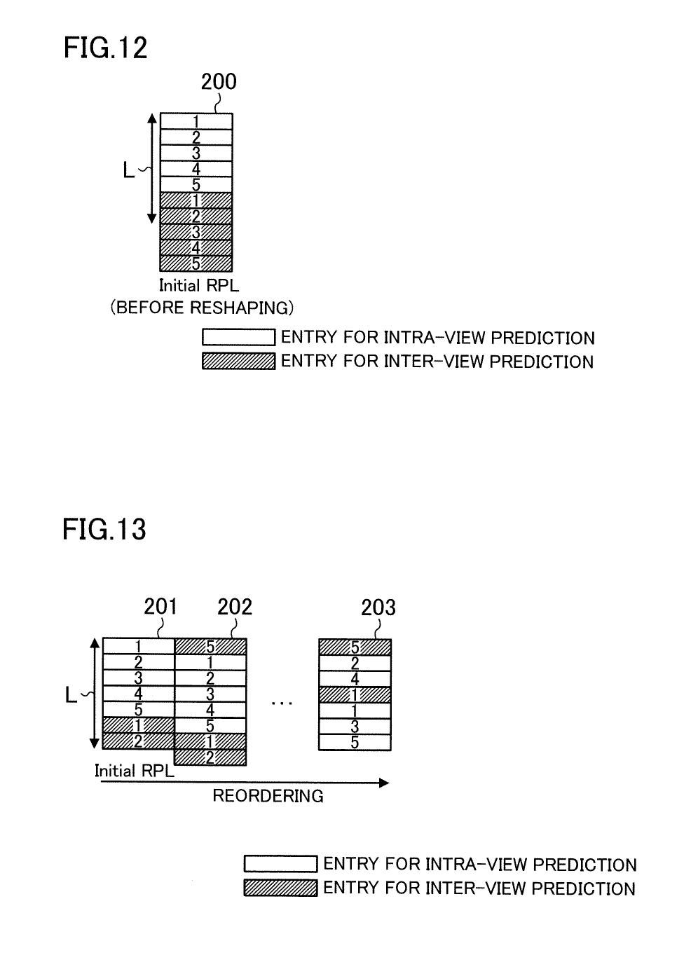

FIG. 12 is a conceptual diagram showing Initial RPL before reshaping which is to be subjected to the search procedure Cl in the multiview video decoding device of the present disclosure. According to the standard, when Initial RPL is generated, entries for intra-view prediction are initially created and entries for inter-view prediction are added to the intra-view prediction entries, and thereafter, the number of entries is reshaped into L (=num_ref_idx_IX_active_minus1+1) and the remaining entries are removed. Note that a target to be subjected to the search procedure C1 is predetermined to be a list 200 which is obtained when entries for inter-view prediction are added, i.e., all entries in Initial RPL before reshaping.

FIG. 13 shows the reordering process which starts to be performed after reshaping of Initial RPL of FIG. 12. According to FIG. 13, a list 201 which is Initial RPL after reshaping is created in addition to the list 200 of FIG. 12. The search target is still the list 200 of FIG. 12. Entries which do not exist in the list 201 which is Initial RPL after reshaping but exist in the list 200 of FIG. 12 can be selected as pictures which are to be associated in ascending order of reference index. Reference characters 202 and 203 of FIG. 13 indicate lists updated by the reordering process including the merge procedure. Note that the list 200 of FIG. 12 in which a region for intra-view prediction entries and a region for inter-view prediction entries are clearly separated from each other is not updated, and therefore, the search range is advantageously limited in each of the MVC process required when the variable modification_of_pic_nums_idc is 0, 1, or 2 and the non-MVC process required when the variable modification_{—} of pic_nums_idc is 4 or 5. Moreover, a flag which is used to distinguish an intra-view prediction entry from an inter-view prediction entry may be prepared and added to each entry, for example, whereby the step of distinguishing an intra-view prediction entry from an inter-view prediction entry can be replaced with the step of referencing the flag in the merge procedure.

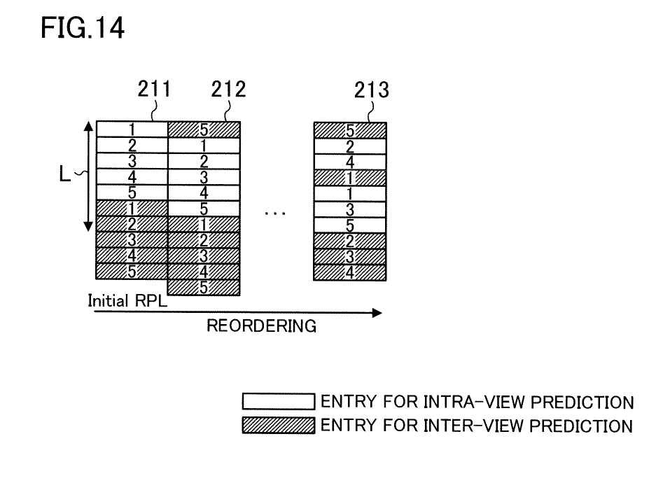

FIG. 14 shows the reordering process which starts to be performed from Initial RPL which is adapted to include the list 200 of FIG. 12. According to FIG. 14, a list 211 which is Initial RPL after reshaping includes the list 200 of FIG. 12. Compared to the case of FIG. 13, the case of FIG. 14 has an advantage that the list 200 which is a search target does not need to be stored in addition to Initial RPL. Reference characters 212 and 213 of FIG. 14 indicate lists updated by the reordering process including the merge procedure. According to FIG. 14, as the reordering process proceeds, the boundary between a region for intra-view prediction entries and a region for inter-view prediction entries disappears, and therefore, it is invariably necessary to search all entries irrespective of the value of the variable modification_of_pic_nums_idc. Note that a flag which is used to distinguish an intra-view prediction entry from an inter-view prediction entry may be prepared and added to each entry, for example, whereby the step of distinguishing an intra-view prediction entry from an inter-view prediction entry can be replaced with the step of referencing the flag in the search and merge procedures.

As described above, the multiview video decoding device of the present disclosure has the advantage of reducing the amount of calculation in the reordering process on the reference picture list, and is useful as a video decoding device conforming to H.264/AVC etc.

What is claimed is:

1. A multiview video decoding device comprising:
a view index selector configured to reference a view ID list which defines an association between a view index or indices and a view ID or IDs, extract only an entry or entries of the view ID list whose view IDs correspond to an inter-view reference flag which is 1, store the view indices of the extracted entry or entries as search targets in a view index storing section, and search for and select a view index equal to a given variable; and
a view ID selector configured to store the view IDs of the extracted entry or entries, and select a view ID based on an address of an entry hit in the view index storing section, wherein
in a process of reordering a reference picture list, a process of determining an inter-view prediction reference picture which is to be inserted at a specific place in the reference picture list is performed by the view index selector and the view ID selector.

2. A multiview video decoding device comprising:
a view ID selector configured to reference a view ID list which defines an association between a view index or indices and a view ID or IDs, using a given variable as an index, to select a view ID; and
an inter-view reference flag determiner configured to validate the selected view ID only when an inter-view reference flag corresponding to the referenced view ID is 1, wherein
in a process of reordering a reference picture list, a process of determining an inter-view prediction reference picture which is to be inserted at a specific place in the reference picture list is performed by the view ID selector and the inter-view reference flag determiner.

3. A multiview video decoding device, wherein
in a process of reordering a reference picture list, a process of determining an inter-view prediction reference picture which is to be inserted at a specific place in the reference picture list is performed by referencing a view ID list which defines an association between a view index or indices and a view ID or IDs, using a fixed value as an index, and is validated only when an inter-view reference flag corresponding to a referenced view ID is 1.

4. A multiview video decoding device comprising:
a section configured to reference a view ID list which defines an association between a view index or indices and a view ID or IDs, extract only an entry or entries of the view ID list whose view IDs correspond to an inter-view reference flag which is 1, and when there are entries having the same view ID in the view ID list, convert a plurality of view indices corresponding to the entries holding the same view ID into any one of the plurality of view indices, and store the extracted entry or entries as search targets together with the converted view index; and
a section configured to, in a process of reordering a reference picture list, convert a given variable in a manner similar to that of the view index, perform a process of determining an inter-view prediction reference picture which is to be inserted at a specific place in the reference picture list by searching for the converted view index which is equal to the converted given variable, and perform a process of determining an inter-view prediction reference picture which is to be inserted after the specific place in the reference picture list by searching entries located after the specific place in the reference picture list for the converted view index which is not equal to the converted given variable.

5. A multiview video decoding method comprising:
referencing a view ID list which defines an association between a view index or indices and a view ID or IDs, extracting only an entry or entries of the view ID list whose view IDs correspond to an inter-view reference flag which is 1, and storing the extracted entry or entries as search targets together with view indices;
in a process of reordering a reference picture list, performing a process of determining an inter-view prediction reference picture which is to be inserted at a specific place in the reference picture list, by searching for one of the view indices which is equal to a given variable.

6. A multiview video decoding method comprising:
in a process of reordering a reference picture list, a process of determining an inter-view prediction reference picture which is to be inserted at a specific place in the reference picture list is performed by referencing a view ID list which defines an association between a view index or indices and a view ID or IDs using a given variable as an index, and is validated only when an inter-view reference flag corresponding to a referenced view ID is 1.

7. A multiview video decoding method comprising:
in a process of reordering a reference picture list, a process of determining an inter-view prediction reference picture which is to be inserted at a specific place in the reference picture list is performed by referencing a view ID list which defines an association between a view index or indices and a view ID or IDs using a fixed value as an index, and is validated only when an inter-view reference flag corresponding to a referenced view ID is 1.

8. A multiview video decoding method comprising:
referencing a view ID list which defines an association between a view index or indices and a view ID or IDs, extracting only an entry or entries of the view ID list whose view IDs correspond to an inter-view reference flag which is 1, and when there are entries having the same view ID in the view ID list, converting a plurality of view indices corresponding to the entries holding the same view ID into any one of the plurality of view indices, and storing the extracted entry or entries as search targets together with the converted view index; and
in a process of reordering a reference picture list, converting a given variable in a manner similar to that of the view index, performing a process of determining an inter-view prediction reference picture which is to be inserted at a specific place in the reference picture list by searching for the converted view index which is equal to the converted given variable, and performing a process of determining an inter-view prediction reference picture which is to be inserted after the specific place in the reference picture list by searching entries located after the specific place in the reference picture list for the converted view index which is equal to the converted given variable.

9. A multiview video decoding device, wherein
in a process of reordering a reference picture list, an entry for intra-view prediction is distinguished from an entry for inter-view prediction based on regions in the reference picture list.

10. A multiview video decoding device, wherein
in a process of reordering a reference picture list, an entry for intra-view prediction is distinguished from an entry for inter-view prediction based on a flag added to each entry.

11. A multiview video decoding method, wherein
in a process of reordering a reference picture list, an entry for intra-view prediction is distinguished from an entry for inter-view prediction based on regions in the reference picture list.

12. A multiview video decoding method, wherein
in a process of reordering a reference picture list, an entry for intra-view prediction is distinguished from an entry for inter-view prediction based on a flag added to each entry.
